(19) United States
(12) Patent Application Publication
(10) Pub. No.: US 2025/0278920 A1
(43) Pub. Date: Sep. 4, 2025

(54) COMPUTER IMPLEMENTED METHOD AND SYSTEM FOR SEMANTIC SEGMENTATION OF WORKSITE

(71) Applicant: Caterpillar Inc., Peoria, IL (US)

(72) Inventors: Pani Prithvi Raj, Chennai (IN); Ramakrishna Mathiraj, Chennai (IN); Sai Praveen Gundlapalli, Chennai (IN)

(73) Assignee: Caterpillar Inc., Peoria, IL (US)

(21) Appl. No.: 18/593,599

(22) Filed: Mar. 1, 2024

(51) Int. Cl. G06V 10/26; G06Q 10/0631; G06T 7/11; G06T 7/50; G06T 7/73; G06V 10/44; G06V 10/774; G06V 10/82; G06V 20/17; G06V 20/50; G06V 20/70

(52) U.S. Cl. CPC G06V 10/273; G06Q 10/06313; G06T 7/11; G06T 7/50; G06T 7/73; G06V 10/44; G06V 10/774; G06V 10/82; G06V 20/17; G06V 20/50; G06V 20/70; G06T 2207/10032; G06T 2207/20021; G06T 2207/20081; G06T 2207/20084; G06T 2207/30181

(57) ABSTRACT

A semantic segmentation model generates semantic segmentation data indicating locations and types of elements at a worksite. The semantic segmentation model generates the semantic segmentation data based on an image depicting the worksite, elevation data indicated by a digital surface model of the worksite, and slope data derived from the digital surface model. Post-processing may enhance the generated semantic segmentation data based on image processing techniques and contextual information indicated by telematics data associated with operations at the worksite.

### TECHNICAL FIELD

The present disclosure relates to analysis of worksites and, more particularly, to using images and digital surface models to identify elements present at worksites.

### BACKGROUND

Machines, such as haul trucks and other work machines, may perform various activities at worksite, such as a mine site, construction site, or other type of worksite. As an example, a haul truck may be loaded with material at a first location at a worksite, and may transport the material to a second location at the worksite. As another example, an excavator may extract material from an area at the worksite, such that the material may be added to a stockpile or transported to one or more other locations.

Various elements may be present at worksites, such as machines, equipment, buildings, stockpiles of material, haul roads or other navigable pathways, bodies of water, and/or other elements. The locations, shapes, and/or types of elements at a worksite may change over time. For example, a stockpile of material may be present at the worksite. However, as material is moved away from the stockpile to one or more other locations over a period of time, the boundaries and/or shape of the stockpile, and/or the volume of material in the stockpile, may change.

Various systems have been developed in the past to identify and/or classify elements at a worksite. For example, Chinese Publication CN112598684A to Luo et al. (hereinafter “Luo”) describes a system that uses semantic segmentation technology classify objects at a mine site based on a color image of the mine site. However, while the system described by Luo may classify objects by evaluating a color image, the system described by Luo may have limited abilities to evaluate other types of data that may increase the accuracy of object classifications generated via semantic segmentation.

Examples of the present disclosure are directed to overcoming the deficiencies noted above.

### SUMMARY

According to a first aspect of the present disclosure, a computer-implemented method includes receiving, by a computing system including a processor, image data depicting a worksite. The computer-implemented method also includes receiving, by the computing system, a digital surface model (DSM) indicating elevation values corresponding to positions at the worksite. The computer-implemented method additionally includes deriving, by the computing system, slope values associated with the positions based on the elevation values indicated by the DSM. The computer-implemented method further includes generating, by the computing system, and using a semantic segmentation model, semantic segmentation data. The semantic segmentation data. identifies one or more types of elements present at the worksite, and locations of the one or more types of elements at the worksite. The semantic segmentation model is a machine learning model configured to generate the semantic segmentation data based on the image data, the elevation values, and the slope values.

According to a second aspect of the present disclosure, a computing system includes a processor and a memory. The memory has, stored thereon, computer-executable instructions. The computer-executable instructions, when executed by the processor, cause the processor to receive, from at least one data source, image data depicting a worksite and a DSM indicating elevation values corresponding to positions at the worksite. The computer-executable instructions also cause the processor to derive slope values associated with the positions, based on the elevation values indicated by the DSM. The computer-executable instructions additionally cause the processor to generate, using a semantic segmentation model, semantic segmentation data. The semantic segmentation data identifies one or more types of elements present at the worksite, and locations of the one or more types of elements at the worksite. The semantic segmentation model is a machine learning model configured to generate the semantic segmentation data based on the image data, the elevation values, and the slope values.

According to a third aspect of the present disclosure, one or more non-transitory computer-readable media has, stored thereon, computer-executable instructions. The computer-executable instructions, when executed by a processor, cause the processor to receive, from at least one data source, image data depicting a worksite and a DSM indicating elevation values corresponding to positions at the worksite. The computer-executable instructions also cause the processor to derive slope values associated with the positions, based on the elevation values indicated by the DSM. The computer-executable instructions also cause the processor to generate, using a semantic segmentation model, semantic segmentation data. The semantic segmentation data identifies one or more types of elements present at the worksite, and locations of the one or more types of elements at the worksite. The semantic segmentation model is a machine learning model configured to generate the semantic segmentation data based on the image data, the elevation values, and the slope values.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is an exemplary diagrammatic illustration of a worksite segmentation system.

FIG. 2 is an exemplary diagrammatic illustration of an example of a semantic segmentation model used by the worksite segmentation system.

FIG. 3 is an exemplary diagrammatic illustration of an example of generation of segmentation data via the semantic segmentation model.

FIG. 4 is an exemplary diagrammatic illustration of an example of post- processing of segmentation data generated by the semantic segmentation model.

FIG. 5 is a flowchart illustrating an exemplary process for training the semantic segmentation model.

FIG. 6 is a flowchart illustrating an exemplary process for using the semantic segmentation model to generate segmentation data associated with a worksite.

FIG. 7 is a schematic illustration depicting an exemplary architecture of a computing system that executes one or more elements described herein.

FIG. 8 is an exemplary diagrammatic illustration of an example comparison of segmentation data generated via different techniques.

### DETAILED DESCRIPTION

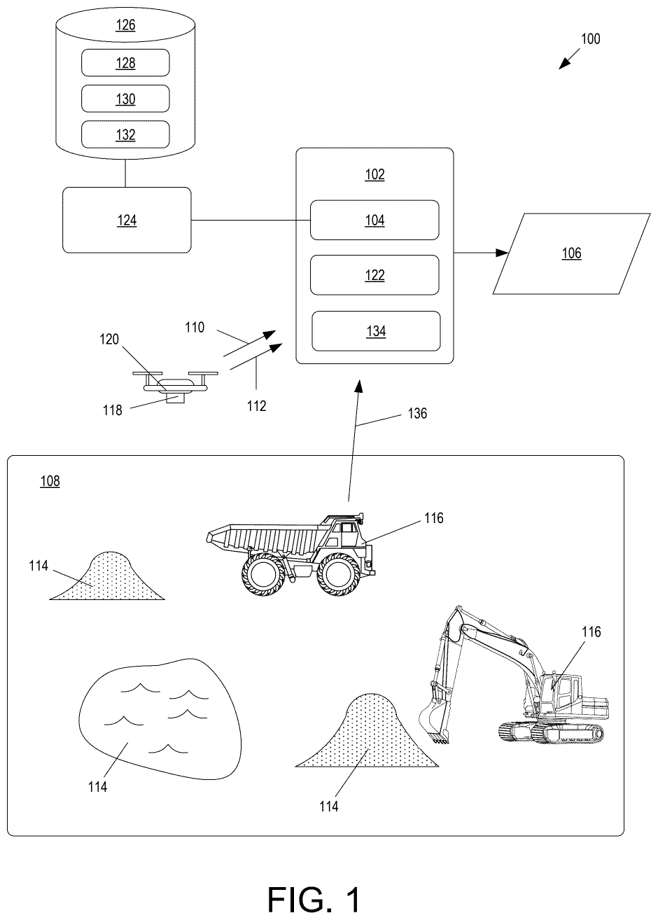

FIG. 1 is an exemplary diagrammatic illustration of a worksite segmentation system 100. The worksite segmentation system 100 may include a computing system 102 configured to use a semantic segmentation model 104 to generate segmentation data 106 associated with a worksite 108. The segmentation data 106 may be a prediction that indicates locations, boundaries, and/or types of elements 114 at the worksite 108.

For instance, the segmentation data 106 may include one or more image masks associated with one or more corresponding types or classes of elements 114. Such image masks may identify pixels that represent locations at the worksite 108 at which corresponding types of elements 114 are likely to be present. Accordingly, pixels that the segmentation data 106 identifies as being associated with the same type of element 114 may indicate one or more locations of that type of element 114 at the worksite 108, as well as shapes and/or boundaries of one or more instances of that type of element 114 at the worksite 108.

The worksite 108 may be a mine site, a quarry, a construction site, or any other type of worksite or work environment. Elements 114 at the worksite 108 may include machines 116, stockpiles of material, haul roads or other navigable paths, loading areas, unloading areas, bodies of water, processing plants, berms, equipment, buildings, and/or other elements.

The worksite segmentation system 100 may be a computer-implemented system that executes via one or more servers, computers, or other computing devices. Computing elements that execute one or more elements of the worksite segmentation system 100 may be present on-site at the worksite 108, and/or may be located at one or more back offices or other locations that are remote from the worksite 108.

The semantic segmentation model 104 used via the worksite segmentation system 100 may be a machine learning model that is configured to generate the segmentation data 106 based on input data. The input data may include image data 110 that depicts the worksite 108, a digital surface model (DSM) 112 that indicates elevation values and/or slope values associated with locations at the worksite 108, and/or other data associated with the worksite 108.

The segmentation data 106 may be a prediction that indicates locations, boundaries, and/or types of elements 114 at the worksite 108. Accordingly, machines 116 may be assigned to perform operations at the worksite 108 based on the locations, boundaries, and/or types of elements 114 indicated by the segmentation data 106. Similarly, operations and/or productivity at the worksite 108 may be tracked based on the locations, boundaries, and/or types of elements 114 indicated by the segmentation data 106.

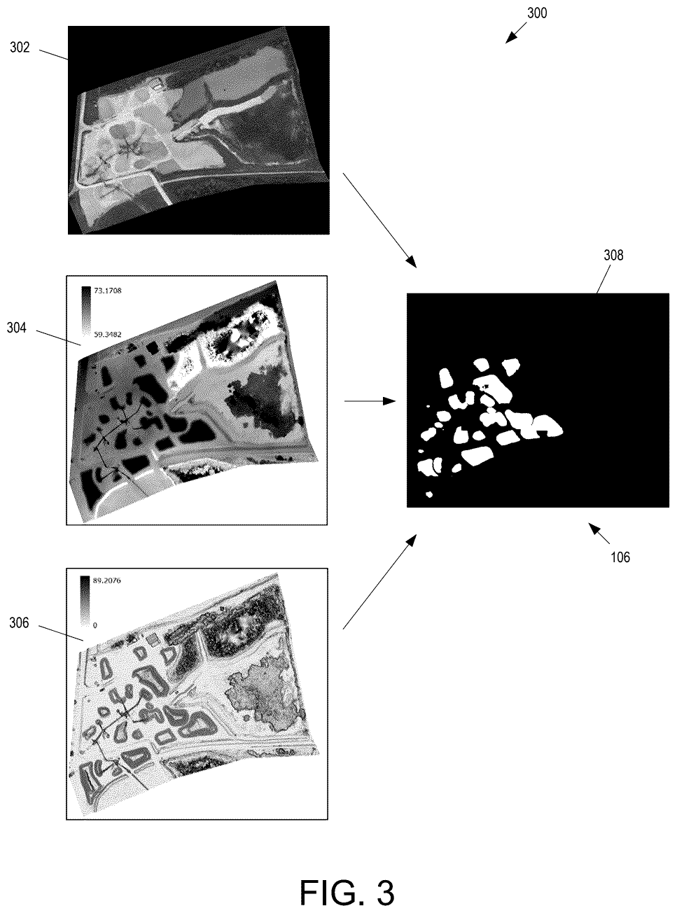

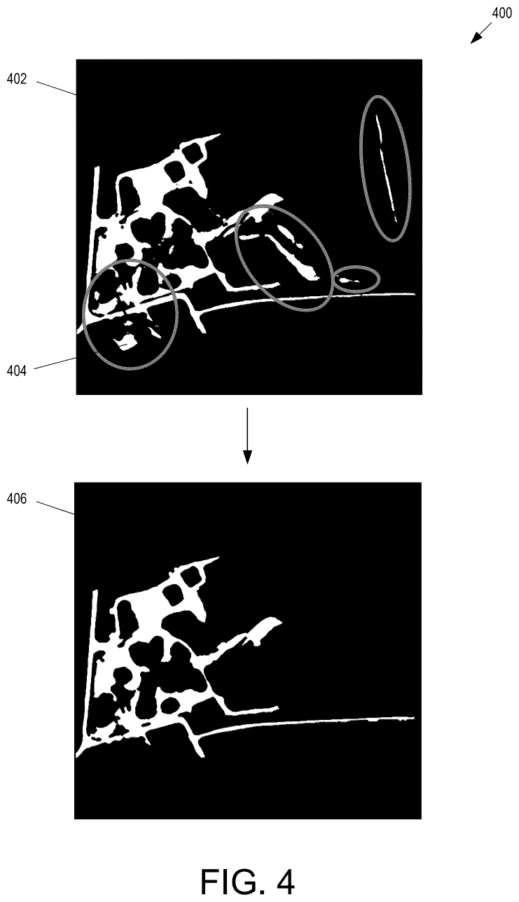

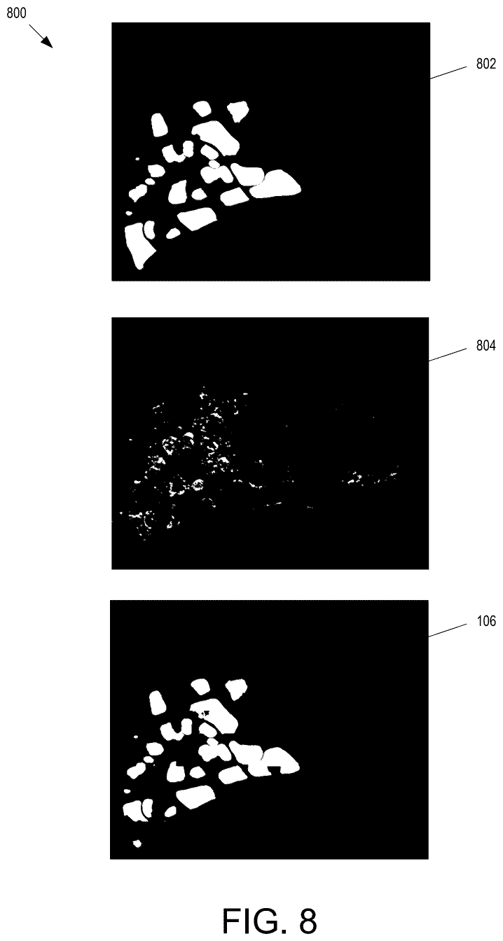

In some examples, the segmentation data 106 may include, or be displayed as, one or more images representing the worksite 108 that are segmented to identify distinct locations and/or boundaries of one or more types of elements 114 at the worksite 108. The segmentation data 106 may accordingly include semantic segmentation data, image masks, and/or other data that indicates boundaries of objects, of one or more corresponding classes, that are segmented from an image. For instance, the segmentation data 106 may include a first image showing the locations of one or more stockpiles at the worksite 108, and a second image showing the locations of one or more roads at the worksite 108. Examples of image-based segmentation data 106 are shown in FIG. 3, FIG. 4, and FIG. 8, and are discussed further below with respect to those figures.

One or more machines 116 may operate at the worksite 108. Such machines 116 may perform one or more types of work operations or tasks at the worksite 108. A machine 116 may, for example, be a commercial or work machine, such as a mining machine, earth-moving machine, backhoe, scraper, dozer, loader (e.g., large wheel loader, track-type loader, etc.), shovel, truck (e.g., mining truck, haul truck, on-highway truck, off-highway truck, articulated truck, etc.), a crane, a pipe layer, a water truck or other machine that dispenses fluid or other material, farming equipment, or any other type of machine or vehicle. In some examples, multiple machines 116 of the same type, and/or different types, may operate at the worksite 108.

The worksite 108 may be a dynamic environment, such that locations, boundaries, and/or types of the elements 114 at the worksite 108 may change over time due to wind, rain, and/or other weather events, operations that are performed at the worksite 108, and/or other factors. As an example, as machines 116 remove material from a stockpile and transport that material to one or more other locations over a period of time, the shape and/or size of the stockpile at the worksite 108 may change. As another example, if machines 116 are tasked to unload material at a new unloading area at the worksite 108, a new stockpile of material may be created at the new unloading area. The new stockpile may also grow and/or change shape over time as additional material is added to the stockpile. As yet another example, rainfall may cause puddles or other bodies of water to appear or grow at one or more locations at the worksite 108. In some situations, such bodies of water may at least temporarily cover haul roads or other elements 114, for instance until the bodies of water dry up.

Although the elements 114 at the worksite 108 may change over time, instances of the segmentation data 106 generated via the worksite segmentation system 100 may be predictions that indicate locations, boundaries, and/or types of elements 114 at the worksite 108 at corresponding times. Accordingly, an instance of the segmentation data 106 that is associated with a particular time may indicate the locations, boundaries, and/or types of elements 114 at the worksite 108 at that particular time, without manual identification of the locations, boundaries, and/or types of the elements 114. Similarly, comparisons of instances of the segmentation data 106 that are associated with different times may be used to identify and/or track changes to elements 114 at the worksite 108 over time.

As described herein, an instance of segmentation data 106 may be generated by the semantic segmentation model 104 based on image data 110, a DSM 112 that indicates elevation values and/or slope values, and/or other data. The data used to generate the segmentation data 106 may be captured and/or generated by one or more sensors 118, such as cameras, Light Detection and Ranging (LiDAR) sensors, and/or other sensors, associated with one or more data sources 120.

In some examples, the one or more data sources 120 may include an unmanned aerial vehicle (UAV), such as an autonomous and/or remotely-controlled drone. For instance, as shown in FIG. 1, an aerial drone may be tasked to fly above the worksite 108 and to use sensors 118 to capture image data 110 and/or a DSM 112 of the worksite 108. In other examples, the one or more data sources 120 may include other types of aerial sources, such as satellites that pass over the worksite 108, airplanes or helicopters that fly over the worksite 108, or other types of vehicles or equipment that may fly or pass over the worksite 108.

In still other examples, the one or more data sources 120 may include machines 116 at the worksite 108 that have sensors 118, and/or may include sensors 118 mounted on buildings, poles, or other fixed locations. In these examples, sensors 118 of such data sources 120 may capture image data 110 depicting at least a portion of the worksite 108, may capture data that may be used to generate at least a portion of a DSM 112, and/or may capture data that may be used to enhance or augment data captured by sensors 118 of one or more drones or other aerial data sources 120.

The image data 110 may include one or more photographs or other images depicting the worksite 108. In some examples, the image data 110 may include an RGB image that indicates colors of pixels based on corresponding red values, green values, and blue values. In other examples, the image data 110 may indicate colors using other values and/or other color spaces or profiles. For instance, the image data 110 may include a CMYK image that indicates colors of pixels based on corresponding cyan values, magenta values, yellow values, and black key values.

The image data 110 may captured as, or may be converted into, an orthophotograph. An orthophotograph may be an adjusted version of a photograph that is modified to present different areas of the worksite 108 at a uniform scale. For example, an orthophotograph may be a version of a captured photograph that has been modified to correct for an angle from which the photograph was captured, to correct for camera lens distortion, to correct for distortions from ground relief, and/or to correct for other issues.

The DSM 112 may be a topographical model that indicates elevations associated with distinct locations at the worksite 108. The DSM 112 may have a scale that corresponds to the scale of an orthophotograph or other image data 110. Accordingly, portions of the DSM 112 that represent areas of the worksite 108 may align with corresponding portions of an orthophotograph or other image data 110 that also represents those areas of the worksite 108. The DSM 112 and corresponding image data 110 may also represent a state of the worksite 108 at the same point in time, or at similar points in time that are within a threshold period of time from each other.

The DSM 112 may indicate elevations associated with a ground surface of the worksite 108, and/or elevations associated with top surfaces of other natural and/or human-made elements 114 present at the worksite 108. For example, the DSM 112 may be represented as an image that indicates elevation values associated with each pixel of the image. Accordingly, an elevation value associated with a particular pixel of the DSM 112 may indicate an elevation associated with a particular location at the worksite 108 that is represented by that particular pixel, such as an elevation associated with the ground of the worksite 108 at that location or an elevation of the top of another type of element 114 that is present at that location.

As an example, the DSM 112 may have pixels representing a ground surface of the worksite 108 and other pixels representing a building at the worksite 108. In this example, the DSM 112 may accordingly indicate that the pixels representing the building are associated with higher elevation values than the pixels representing the ground surface. As another example, the DSM 112 may have pixels representing an uneven ground surface of the worksite 108. The DSM 112 may accordingly indicate that pixels representing ditches or other depressions in the uneven ground surface have lower elevations than pixels representing hills or other higher portions of the uneven ground surface.

The DSM 112 may be captured and/or generated based on LiDAR techniques, photogrammetry techniques, and/or other techniques. For example, a LiDAR sensor on a drone or other data source 120 may use lasers to measure distances between the LiDAR sensor and points at the worksite 108, such that a point cloud of elevation values associated with the worksite 108 may be determined based on the measured distances. As another example, the DSM 112 may be generated via photogrammetry by using a set of photographs of the worksite 108 to generate a three- dimensional model of the worksite 108 that indicates elevation values of distinct points at the worksite 108.

Although the DSM 112 may indicate elevation values as discussed above, other information about the worksite 108 may be indicated by the DSM 112 or may be derived from the DSM 112. For example, a data source 120, the computing system 102, and/or another element associated with the worksite segmentation system 100 may derive slope information associated with the worksite 108 based on differences between elevation values indicated by the DSM 112.

For instance, the computing system 102 may have a slope derivation component 122 that is configured to derive slope values from elevation values indicated by the DSM 112. As discussed above, the DSM 112 may indicate elevation values associated with locations at the worksite 108. The slope derivation component 122 may be configured to derive slope values associated with such locations, based on differences between elevation values indicated by the DSM 112. As an example, if a first pixel of the DSM 112 that represents a first location at the worksite 108 is associated with first elevation value, and a second pixel of the DSM 112 that represents a second location at the worksite 108 is associated with second elevation value, the slope derivation component 122 may determine a slope between the first location and the second location based on a difference between the first elevation value and the second elevation value.

In other examples, the DSM 112 may directly indicate slope information. For instance, a data source 120 that captures elevation data and/or generates the DSM 112 may have an instance of the slope derivation component 122, and may use the slope derivation component 122 to determine slope values that correspond to measured elevation values. The data source 120 may accordingly indicate the slope values in the DSM 112, or otherwise provide the slope values to the computing system 102 along with elevation values and/or the DSM 112 provided to the computing system 102.

As described above, one or more data sources 120 may capture and/or generate image data 110 and/or the DSM 112 associated with the worksite 108. One or more data sources 120 may also capture and/or generate instances of the image data 110 and/or the DSM 112 at different times. For example, a drone may be tasked to fly above the worksite 108 and capture image data 110 and/or a DSM 112 once per hour, once per day, or an any other regular or irregular schedule.

The one or more data sources 120 may provide instances of the image data 110 and/or the DSM 112 to the computing system 102 via a network or other data connection. For instance, the one or more data sources 120 may transmit the image data 110 and/or the DSM 112, and/or corresponding data, to the computing system 102 via a Wi-Fi connection, a cellular data connection, or any other wireless or wired data connection.

In some examples, the one or more data sources 120 may use sensors 118 to capture data, and may perform processing operations to convert the captured data into image data 110 and/or a DSM 112. For example, a data source 120 may convert a captured image into an orthophotograph, and/or convert captured distance or elevation data into a DSM 112, such that the one or more data sources 120 may provide the generated orthophotograph and the DSM 112 to the computing system 102. The data source 120 may, in some examples, also derive slope data associated with the DSM 112, and provide the slope data to the computing system 102 in or along with the DSM 112. In other examples, a data capture source may send captured data to the computing system 102, such that the computing system 102 may process the captured data to convert a captured image into an orthophotograph, generate a DSM 112, and/or derive slope data associated with the DSM 112. For example, a drone may use a LiDAR sensor to measure elevations based on distances between the drone and points at the worksite 108, and may provide corresponding elevation information to the computing system 102 so that that the computing system 102 may use the elevation information to generate a DSM 112 and/or derive corresponding slope data.

The semantic segmentation model 104 may use image data 110, such as an orthophotograph, and elevation and/or slope data indicated by a corresponding DSM 112 to generate segmentation data 106 associated with the worksite 108. The semantic segmentation model 104 may be a machine learning model, such as a machine learning model based on convolutional neural networks, recurrent neural networks, other types of neural networks, nearest-neighbor algorithms, regression analysis, deep learning algorithms, Gradient Boosted Machines (GBMs), Random Forest algorithms, and/or other types of artificial intelligence or machine learning frameworks.

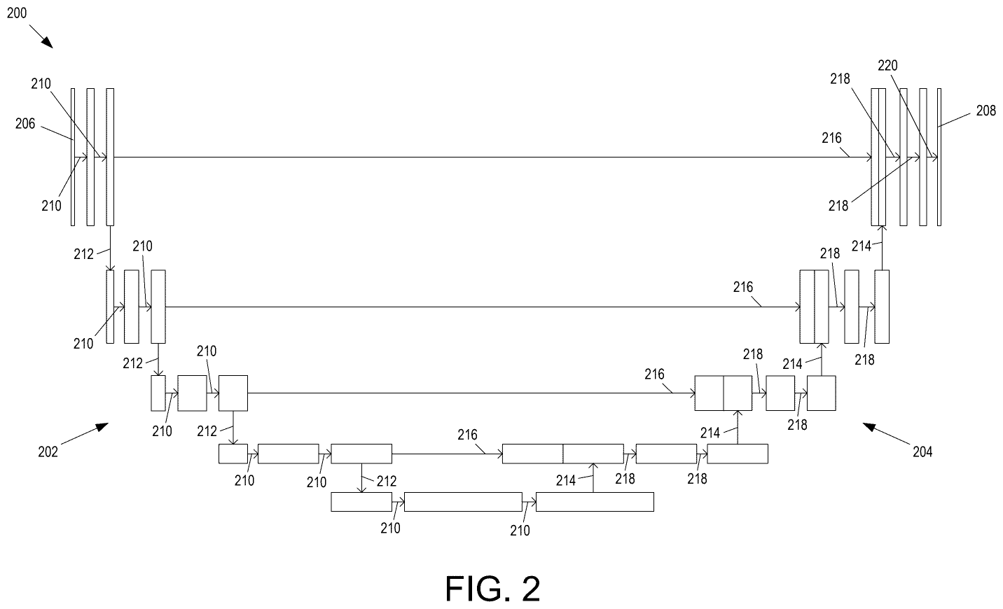

The semantic segmentation model 104 may be a computer vision model that is trained and/or configured to determine the shape and/or position of one or more classes of elements 114 within images. As described herein, such images may be associated with input data such as the image data 110, images indicating elevation values and/or slope values associated with the DSM 112, and/or other data. As an example, the semantic segmentation model 104 may be an image segmentation model, such as a U-Net model that is based on a deep learning neural network architecture, as discussed further below with respect to FIG. 2.

The semantic segmentation model 104 may be trained, via a training system 124, based on a training data set 126. In some examples the training system 124 may be executed by the computing system 102. In other examples, the training system 124 may be executed via a separate computing system that may be different than, and/or remote from, the computing system 102. For instance, in some examples, the training system 124 may execute via a remote server and may train the semantic segmentation model 104, and the computing system 102 may access and/or retrieve a trained version of the semantic segmentation model 104 over a network from the training system 124. The training system 124 may also re-train and/or otherwise update the semantic segmentation model 104 over time, for instance based on new or updated training data sets 126. Accordingly, the computing system 102 may access and/or use a most recent version of the semantic segmentation model 104 from the training system 124.

The training data set 126 may include training image data 128, training DSMs 130, and training segmentation data 132. The training image data 128 may be similar to the image data 110 discussed above, and may include orthophotographs and/or other images depicting one or more example worksites at corresponding times. The training DSMs 130 may be similar to the DSM 112 discussed above, and may indicate elevation data associated with the one or more example worksites in association with corresponding times. The training DSMs 130 may also indicate slope data associated with the one or more example worksites, and/or the training system 124 may use an instance of the slope derivation component 122 to service such slope data from the training DSMs 130.

The training segmentation data 132 may indicate locations, boundaries, and/or types of elements 114 at the one or more example worksites at corresponding times. The training segmentation data 132 may be generated by one or more human analysts, such as subject matter experts, who manually evaluated the example worksites in person, and/or based on analysis of images and/or other data associated with the example worksites, to determine the locations, boundaries, and/or types of elements 114 that were present at the example worksites at corresponding times. The training segmentation data 132 may accordingly be considered to be ground truth data indicating the locations, boundaries, and/or types of elements 114 that were present at the example worksites at those times.

The training data set 126 may accordingly include instances of training image data 128, training DSMs 130, and training segmentation data 132 that are associated with the same times and/or the same example worksites. The training system 124 may accordingly use the training data set 126 to train the semantic segmentation model 104 to predict, based on the training image data 128 and the training DSMs 130, the locations, boundaries, and/or types of elements 114 that the training segmentation data 132 indicates were present at corresponding example worksites at corresponding times.

As an example, the training system 124 may use a supervised machine learning approach to train the semantic segmentation model 104. In such a supervised machine learning approach, the training system 124 may use the locations, boundaries, and/or types of elements 114 indicated by the training segmentation data 132 as labels. The training system 124 may also determine which features, and/or which combinations of features, associated with the training image data 128 and the training DSMs 130 may be used to generate predictions of segmentation data that most accurately reproduce the labeled locations, boundaries, and/or types of elements 114 indicated by the training segmentation data 132. The training system 124 may also determine and/or adjust other parameters of the semantic segmentation model 104 during training of the semantic segmentation model 104. For example, during training of the semantic segmentation model 104, the training system 124 may adjust which features are used by the semantic segmentation model 104, adjust a number of features that are used by the semantic segmentation model 104, adjust weights associated with the features, and/or determine other parameters that may be used to generate predictions of segmentation data that most accurately reproduce the labeled locations, boundaries, and/or types of elements 114 indicated by the training segmentation data 132. The training system 124 may accordingly train and/or re-train the semantic segmentation model 104 by selecting different features, selecting different combinations of features, adjusting weights associated with different features, and/or otherwise adjusting parameters of the semantic segmentation model 104 until the semantic segmentation model 104 is able to use the training image data 128 and the training DSMs 130 to generate predictions of segmentation data that match the training segmentation data 132 to at least a threshold degree of accuracy.

In some examples, the training system 124 may select random patches of the training image data 128 and corresponding training DSMs 130 that represent the same areas of example worksites at the same times, and train the semantic segmentation model 104 based on the selected patches. For example, rather than training the semantic segmentation model 104 based on an entire orthophotograph of an example worksite and corresponding elevation values and/or slope values associated with the entire example worksite indicated by a training DSM 130, the training system 124 may train the semantic segmentation model 104 based on smaller rectangles that are randomly selected from within the orthophotograph, along with elevation values and/or slope values that correspond with areas of the example worksite depicted by the randomly-selected rectangles. However, in other examples, the training system 124 may training the semantic segmentation model 104 based on an entire orthophotograph of an example worksite and corresponding elevation values and/or slope values associated with the entire example worksite indicated by a training DSM 130.

After the training system 124 has trained the semantic segmentation model 104, the computing system 102 may use a trained instance of the semantic segmentation model 104 to generate segmentation data 106 associated with the worksite 108 based on image data 110 and corresponding DSMs 112 associated with the worksite 108. For example, the semantic segmentation model 104 may obtain image data 110 and a corresponding DSM 112 that both reflect a state of the worksite 108 at a particular time. In some examples, the semantic segmentation model 104 may also obtain slope data associated with the DSM 112, for instance from the slope derivation component 122. The semantic segmentation model 104 may use instances of predictive data features, identified via the training of the semantic segmentation model 104, that are indicated by image data 110 and data indicated by and/or derived from the DSM 112 to generate segmentation data 106 associated with the particular time. The generated segmentation data 106 may indicate predictions of locations, boundaries, and/or types of elements 114 at the worksite 108 at the particular time.

The semantic segmentation model 104 may be trained and/or configured to use and/or evaluate features in multiple channels that are indicated by the training image data 128 and/or the training DSMs 130. Accordingly, the semantic segmentation model 104 may use instances of those features, in multiple channels, that are indicated by image data 110 and corresponding DSMs 112 to generate segmentation data 106.

As an example, if the training image data 128 and/or the image data 110 includes color images, the semantic segmentation model 104 may be trained and/or configured to use features of images in channels associated with multiple colors. For instance, if the training image data 128 and/or the image data 110 includes RGB orthophotographs, the semantic segmentation model 104 may be trained and/or configured to use features of an orthophotograph in a red channel, a green channel, and a blue channel.

As another example, the semantic segmentation model 104 may be trained and/or configured to use elevation features indicated by the training DSMs 130 and/or DSMs 112. As discussed above, DSMs 112 may indicate elevation values associated with locations at the worksite 108, and the training DSMs 130 may similarly indicate elevation values associated with locations at example worksites. Accordingly, the features used by the semantic segmentation model 104 may include elevation features, associated with an elevation channel, that are indicated by a DSM.

As yet another example, the semantic segmentation model 104 may be trained and/or configured to use slope features indicated by the training DSMs 130 and/or instances of the DSM 112. As discussed above, DSMs 112 may indicate elevation values associated with locations at the worksite 108, and the training DSMs 130 may similarly indicate elevation values associated with locations at example worksites. The slope derivation component 122 and/or other elements may be configured to derive slope values associated with such locations, based on differences between corresponding elevation values. Accordingly, the features used by the semantic segmentation model 104 may include slope features, associated with a slope channel, that are indicated by a DSM and/or that may be derived from elevation values indicated by a DSM.

Accordingly, in some examples, the semantic segmentation model 104 may be trained and/or configured to use features in a red channel, a green channel, a blue channel, an elevation channel, and a slope channel to generate an instance of segmentation data 106. The features of the red channel, the green channel, and the blue channel may be derived from RBG image data 110, such as an RBG orthophotograph of the worksite 108. The features of the elevation channel and the slope channel may be indicated by, and/or may be derived from, a DSM 112 associated with the worksite 108. In other examples, the semantic segmentation model 104 may be trained and/or configured to use features in a different set of channels to generate segmentation data 106.

The segmentation data 106 generated by the semantic segmentation model 104 based on the image data 110 and the DSM 112 may indicate predicted locations, boundaries, and/or types of elements 114 that are or were present at the worksite 108 at a time when the image data 110 and the DSM 112 were captured. As an example, if the image data 110 and the DSM 112 were captured at 9:00 AM on a particular day, the image data 110 and the DSM 112 may represent a state of the worksite 108 at 9:00 AM on that particular day. The segmentation data 106, generated based on the image data 110 and the DSM 112, may accordingly be a prediction of the locations, boundaries, and/or types of elements 114 present at the worksite 108 at 9:00 AM on that particular day. Another example of segmentation data 106 generated by the semantic segmentation model 104 is shown in FIG. 3, and is discussed further below with respect to that figure.

In some examples, the computing system 102 may have a post-processing component 134 configured to augment, enhance, or otherwise adjust the segmentation data 106 generated by the semantic segmentation model 104. An example of a modification, by the post-processing component 134, of segmentation data 106 generated by the semantic segmentation model 104 is shown in FIG. 4, and is discussed further below with respect to that figure. The post-processing component 134 may be configured to use noise correction techniques, binary closing techniques, and/or other image processing techniques to augment, enhance, or otherwise adjust the segmentation data 106. The post-processing component 134 may adjust the segmentation data 106 to remove likely errors and/or to otherwise cause the segmentation data 106 to more accurately reflect actual locations, boundaries, and/or types of elements 114 at the worksite 108.

As an example, the segmentation data 106 may indicate predicted locations of haul roads at the worksite 108. However, noise in the segmentation data 106 generated by the semantic segmentation model 104 and/or inaccuracies in the predictions indicated by the segmentation data 106 may lead to the segmentation data 106 depicting a relatively small gap between two identified portions of a haul road. The post-processing component 134 may be configured to determine that the gap depicted between the identified portions of the haul road is likely due to noise and/or prediction inaccuracies, and likely does not reflect an actual gap in the haul road. Accordingly, the post-processing component 134 may adjust the segmentation data 106 to fill in the gap and connect the identified portions of the haul road, such that the modified segmentation data 106 depicts a continuous haul road and omits the gap.

However, as another example, the segmentation data 106 may indicate predicted locations of haul roads at the worksite 108 and also indicate predicted locations of bodies of water at the worksite 108. In this example, the segmentation data 106 may depict a gap in a haul road, but the segmentation data 106 may also indicate that water is predicted to be located at the position of the depicted gap in the haul road. For instance, a rainstorm may have caused the haul road to flood at the position of the depicted gap. In this example, the post-processing component 134 may use a prediction of water elements 114 indicated by the segmentation data 106 to determine that there is water on the haul road that may make the haul road non- traversable. The post-processing component 134 may accordingly determine not to adjust the segmentation data 106 to fill in the gap in the haul road, as the gap in this example may be likely to be due to identified water that may prevent machines 116 from traveling along the haul road, instead of noise and/or prediction inaccuracies. In other examples, the post-processing component 134 may instead be configured to adjust the segmentation data 106 in this situation, by filling in the gap and connecting the identified portions of the haul road, because the haul road is likely to exist and be present under the identified water.

The post-processing component 134 may also, or alternately, be configured to use telematics data 136 associated with one or more machines 116 to adjust the segmentation data 106. For example, the telematics data 136 may indicate locations of the machines 116, routes traveled by the machines 116, speeds at which the machines 116 traveled, identifications of operations performed by the machines 116, information about payloads carried by the machines 116, such as weights, material types, fuel and/or other payload information, battery status information associated with the machines 116, images captured by cameras on-board the machines 116, sensor data captured by sensors 118 on-board the machines 116, and/or any other type of information. In some examples the telematics data 136 may be transmitted to the computing system 102 from the machines 116 directly. In other example, a worksite management system or other separate system associated with the machines 116 and/or the worksite 108 may receive and/or track telematics data 136 associated with the machines 116, and may provide the telematics data 136 to the computing system 102.

The post-processing component 134 may use the telematics data 136 to modify the segmentation data 106 generated by the semantic segmentation model 104. For instance, the post-processing component 134 may use the telematics data 136 to determine contextual information associated with operations at the worksite 108 that are associated with elements 114 identified by the segmentation data 106. The post-processing component 134 may accordingly add corresponding tags, metadata, and/or other contextual data to the segmentation data 106.

As an example, the segmentation data 106 generated by the semantic segmentation model 104 may depict locations and/or boundaries of multiple stockpiles at the worksite 108, but may not initially indicate what types of materials are or were in those stockpiles. However, the telematics data 136 may indicate that machines 116 have been loaded with a first type of material at or near a location of a first stockpile indicted by the segmentation data 106, and have been loaded with a second type of material at or near a location of a second stockpile indicted by the segmentation data 106. For instance, the telematics data 136 may include images of material loaded onto the machines 116 that were captured by cameras on-board the machines 116, such that image recognition techniques may be used to determine the types of material loaded onto the machines 116 at the different locations. Alternately, the telematics data 136 may indicate weights of payloads carried by the machines that may be indicative of the types of material loaded onto the machines 116 at the different locations, or may indicate any other information that may be indicative of the types of material loaded onto the machines 116 at the different locations. Accordingly, the post-processing component 134 may adjust the segmentation data 106, based on the telematics data 136, to indicate that the first stockpile depicted in the segmentation data 106 is likely to be associated with the first type of material and that the second stockpile depicted in the segmentation data 106 is likely to be associated with the second type of material.

As another example, the segmentation data 106 generated by the semantic segmentation model 104 may depict locations and/or boundaries of multiple stockpiles of material at the worksite 108. However, the segmentation data 106 may not initially indicate whether individual stockpiles are associated with loading areas at which material from the stockpiles are loaded onto machines 116 and are transported away from the stockpiles, or are associated with unloading areas at which material transported by machines 116 are added to the stockpiles. However, the telematics data 136 may indicate that machines 116 have been tasked to perform loading operations at or near the location of a first stockpile identified by the initial segmentation data 106, and have been tasked to perform unloading operations at or near the location of a second stockpile identified by the initial segmentation data 106. Accordingly, the post-processing component 134 may adjust the segmentation data 106, based on the telematics data 136, to indicate that the first stockpile depicted in the segmentation data 106 is likely to be associated with a loading area and that the second stockpile depicted in the segmentation data 106 is likely to be associated with an unloading area.

As yet another example, the segmentation data 106 generated by the semantic segmentation model 104 may identify locations of a haul road and a body of water. Similar to an example discussed above, the identified body of water may intersect the haul road, such that the segmentation data 106 depicts a corresponding gap in the haul road. The initial segmentation data 106 may not indicate whether the identified water is a shallow puddle that would not prevent machines 116 from traversing the haul road or a deeper pool or water that would prevent machines 116 from traversing the haul road. However, the telematics data 136 may indicate whether or not machines 116 have been traveling along the haul road and have been passing through the identified water on the haul road. Accordingly, if the telematics data 136 indicates that the identified water has not been preventing machines 116 from traveling along the haul road, the post-processing component 134 may adjust the segmentation data 106 to remove the gap and connect the other identified portions of the haul road as discussed above. However, if the telematics data 136 instead indicates that the identified water has not preventing machines 116 from traveling along the haul road, the post-processing component 134 may determine not to adjust the segmentation data 106 such that the segmentation data 106 depicts the non-navigable gap in the haul road.

Overall, the semantic segmentation model 104 may use image data 110 and the DSM 112, for instance based on elevation data and/or slope data indicated by the DSM 112, to generate segmentation data 106 that indicates locations, boundaries, and/or types of elements 114 at the worksite 108. The segmentation data 106 may be displayed to one or more users, may be output to other systems, and/or may be used in other ways. For example, as described further below, a worksite management system executed via the computing system 102 or another computing system may use the segmentation data 106 to assign machines 116 to perform operations at the worksite 108, to track operations and/or productivity at the worksite 108 based on the locations, boundaries, and/or types of elements 114 indicated by the segmentation data 106, and/or for other purposes. An example of the semantic segmentation model 104 that may be used to generate the segmentation data 106 is discussed further below with respect to FIG. 2.

FIG. 2 is an exemplary diagrammatic illustration of an example of the semantic segmentation model 104. As discussed above, the semantic segmentation model 104 may be a machine learning model. In the example shown in FIG. 2, the semantic segmentation model 104 may be a U-Net model 200.

The U-Net model 200 may be an image segmentation model that is based on a fully convolutional neural network. The U-Net model 200 may determine an element classification associated with each pixel of an image, and may accordingly generate image masks of pixels that indicate locations, shapes, and/or boundaries of the same types of elements 114. For example, the U-Net model 200 may determine whether a particular pixel of an input image, such as an orthophotograph or other image data 110, depicts a stockpile, a machine 116, a haul road, or any other type of element 114. The U-Net model 200 may accordingly find all of the pixels in the input image that are likely to depict the same type of element 114, and may generate corresponding segmentation data 106 as an image mask that identifies the pixels associated with that type of element 114. The U-Net model 200 may generate different image masks associated with different types of elements 114, such as a first image mask that identifies pixels representing stockpiles, a second image mask that identifies pixels representing haul roads, a third image mask that identifies pixels representing machines 116, and/or any other image masks associated with other corresponding types of elements 114.

As shown in FIG. 2, the U-Net model 200 may have a “U-shaped” architecture with a contracting path 202 and an expansive path 204. The contracting path 202 may be associated with an encoder, while the expansive path 204 may be associated with a decoder. An input patch 206, such as a tile, rectangle, or other portion of an input image, may be provided to the contracting path 202. The input patch 206 may have pixel values and/or other data associated with multiple channels, such as a red channel, a green channel, and a red channel associated with an orthophotograph or other image data 110, and an elevation channel and a slope channel associated with a corresponding DSM 112. The expansive path 204 may output a segmentation data patch 208 that corresponds to the provided input patch 206. The segmentation data patch 208 may be a portion of segmentation data 106. Accordingly, the U-Net model 200 may operate separately on different input patches 206 of input data to generate corresponding segmentation data patches 208 of the segmentation data 106, such that the segmentation data patches 208 may be combined into the full segmentation data 106.

The contracting path 202 may include multiple stages that operate to downsample an input patch 206, and to identify or classify features depicted in the input patch 206. Each stage of the contracting path 202 may include convolutional layers, and may apply rectified linear unit (ReLU) operations. As an example, first operations 210 such as two 3×3 unpadded convolutions and ReLU operations may be performed at each stage of the contracting path 202. After each non-final stage of the contracting path 202, second operations 212 may be performed before the next stage of the contracting path 202. The second operations 212 may apply max pooling operations, such as 2×2 max pooling. The stages of the contracting path 202 may accordingly double the number of feature channels. A final stage of the contracting path 202 may apply the first operations 210 to generate a feature map. The feature map may be a downsampled version of the input patch 206.

The expansive path 204 may then upsample the feature map generated by the contracting path 202, and may determine information indicating where the features identified via the contracting path 202 are located. The expansive path 204 may also include multiple stages. At each stage of the expansive path 204, third operations 214 such as upsampling 2×2 up-convolutions may be applied to output of the preceding stage, such as the final stage of the contracting path 202 or a preceding stage of the expansive path 204, which may halve the number of feature channels.

Fourth operations 216 involving a residual addition of output from a corresponding stage of the contracting path 202 may also be performed at each stage of the expansive path 204. For example, the output of the third operations 214 at each stage may be concatenated with a skip layer connection from a corresponding stage of the contracting path 202 via the fourth operations 216. The skip layers connections used in the fourth operations 216 may allow the expansive path 204 to use feature identification data determined via the stages of the contracting path 202 to determine where the features indicated by the feature map output by the final stage of the contracting path 202 are located within upsampled data generated via the third operations 214.

Fifth operations 218, such as 3×3 convolutions and ReLU operations, may also be applied at each stage of the expansive path 204. Output of each non-final stage of the expansive path 204 may be provided to the next stage of the expansive path 204, which may similarly apply the third operations 214, the fourth operations 216, and the fifth operations 218. The final stage of the expansive path 204 may apply sixth operations 220, such as a 1×1 convolution and/or a sigmoid activation operation, to generate a segmentation data patch 208 that indicates a per-pixel classification of which type of element 114 is likely to be represented by each pixel of the segmentation data patch 208.

As discussed above, the U-Net model 200 may operate on different input patches 206 to generate corresponding segmentation data patches 208 of the segmentation data 106. The input patches 206 and the corresponding segmentation data patches 208 may represent different areas of the worksite 108. The U-Net model 200 and/or other elements executed by the computing system 102 may combine segmentation data patches 208 representing different areas of the worksite 108 into segmentation data 106 that represents the full worksite 108 or a larger area of the worksite 108. The segmentation data 106 generated via the U-Net model 200 may indicate locations, boundaries, and/or types of elements 114 at the worksite 108. Examples of segmentation data 106 are shown in FIG. 3, FIG. 4, and FIG. 8, and are discussed further below with respect to those figures.

FIG. 3 is an exemplary diagrammatic illustration of an example 300 of generation of segmentation data 106. As discussed above, the semantic segmentation model 104 may generate segmentation data 106 based on input data that represents a state of the worksite 108. The input data may include image data 110, such as an orthophotograph 302 as shown in FIG. 1. The input data may also include information indicated by, and/or derived from, a DSM 112, such as elevation data 304 and slope data 306.

The orthophotograph 302 may be, or may be derived from, image data 110 captured by a data source 120. For example, a drone, a satellite, or other data source 120 may use a camera to capture a photograph that depicts the worksite 108. The data source 120 or the computing system 102 may convert the captured photograph into the orthophotograph 302, for example to correct for lens distortions, to correct distortions due to an angle at which the photograph was captured, and/or to correct for other issues. Although a grayscale version of the orthophotograph 302 is shown in FIG. 3, the orthophotograph 302 may be color image, such as an RBG image. Accordingly, pixels of the orthophotograph 302 may indicate data associated with multiple color channels, such as a red channel, a blue channel, and a green channel.

The elevation data 304 and the slope data 306 may be indicated by, and/or derived from, a DSM 112 captured by a data source 120. For example, a drone, a satellite, or other data source 120 may use a LiDAR sensor, a camera, and/or other sensors 118 to measure, and/or capture information indicating, elevations of locations at the worksite 108 that are represented by corresponding pixels of the DSM 112. Such elevation data may be used as the elevation data 304. Additionally, the data source 120, the computing system 102, or another element may derive the slope data 306 from the elevation data 304 indicated by the DSM 112. For example, the slope derivation component 122 of the computing system 102 may use differences between elevation values associated with different pixels of the DSM 112, and differences between locations of those pixels within the DSM 112, to determine corresponding slope values. The determined slope values may be stored or provided as the slope data 306.

In some situations, the elevation data 304 and/or the slope data 306 may indicate locations and/or boundaries of elements 114 that may not be directly indicated by color channels of the orthophotograph 302. For example, if a color of a stockpile of material is relatively similar to the color of a ground surface adjacent to the stockpile, the stockpile may be relatively difficult to detect based on color differences indicated by the orthophotograph 302. However, the elevation data 304 may indicate that pixels representing the stockpile are associated with higher elevation values than pixels representing the surrounding ground surface. Such differences in the elevation values indicated by the elevation data 304 may accordingly assist the semantic segmentation model 104 in distinguishing pixels that represent the stockpile from pixels that represent the ground surface.

In some situations, the slope data 306 may also indicate locations and/or boundaries of elements 114 that may not be directly indicated by color channels of the orthophotograph 302 or the elevation data 304. For example, if a stockpile has a relatively flat top surface, pixels representing the stockpile may be associated with relatively similar elevation values in the elevation data 304 and may be associated with relatively low slope values. However, edges of the stockpile that extend upwards from a relatively flat ground surface to the relatively flat top surface of the stockpile may be associated with relatively high slope values in the slope data 306. Accordingly, the relatively high slope values in the slope data 306 may assist the semantic segmentation model 104 in identifying pixels representing a boundary that extends around the edges of the stockpile.

As another example, the roof of a building and the top surface of a stockpile may be relatively flat. The stockpile may have a similar height as the building. Accordingly, pixels representing the building and the stockpile may be associated with similar elevation values in the elevation data 304. However, the building may have vertical walls, while the stockpile may have more gradually sloped edges that extend upwards from a relatively flat ground surface to the relatively flat top surface of the stockpile. Accordingly, in this example, differences in the slope values associated with the edges of the building and the stockpile may assist the semantic segmentation model 104 in distinguishing pixels that represent the building from pixels that represent the stockpile.

As shown in FIG. 3, input data used by the semantic segmentation model 104 may be associated with color channels indicated by the orthophotograph 302, an elevation channel indicated by the elevation data 304 of the DSM 112, and/or a slope channel derived indicated by the slope data 306 derived from elevation data 304 of the DSM 112. The semantic segmentation model 104 may use the input data to generate corresponding segmentation data 106, such as one or more image masks 308 associated with different types of elements 114, as shown in FIG. 3.

For example, as shown in FIG. 3, the segmentation data 106 may include an image mask 308 associated with stockpile elements 114 at the worksite 108. The image mask 308 associated with the stockpile elements 114 may show pixels that are predicted to represent stockpiles in white, and show other pixels that are not predicted to represent stockpiles in black. Although the segmentation data 106 shown in FIG. 3 is an image mask 308 associated with stockpiles, the segmentation data 106 generated by the semantic segmentation model 104 may also include other image masks 308 associated with other types of elements 114, or the semantic segmentation model 104 may generate different instances of segmentation data 106 that are associated with different types of elements 114. For instance, in some examples the segmentation data 106 may be, or include, image masks 308 that identify pixels that are predicted to represent roads, pixels that are predicted to represent bodies of water, pixels that are predicted to represent buildings, pixels that are predicted to represent machines 116, and/or pixels that are predicted to represent any other type or class of element 114.

As discussed above, the computing system 102 may have a post-processing component 134 that may modify segmentation data 106 generated by the semantic segmentation model 104. An example of an initially-generated version of segmentation data 106 being modified by the post-processing component 134 is shown in FIG. 4, and is discussed further below.

FIG. 4 is an exemplary diagrammatic illustration of an example 400 of post-processing of segmentation data 106. The semantic segmentation model 104 may use input data, such as an orthophotograph 302, elevation data 304, and/or slope data 306, to generate segmentation data 106 as discussed above with respect to FIG. 3. The segmentation data 106 generated and output by the segmentation data 106 may be initial segmentation data 402 as shown in FIG. 4. In some examples, the initial segmentation data 402 may include noise, have image artifacts, or have other issues that cause the initial segmentation data 402 to inaccurately represent boundaries and/or locations of some elements 114.

For example, the initial segmentation data 402 shown in FIG. 4 may be an image mask that identifies pixels predicted to represent haul roads at the worksite 108. However, as shown in FIG. 4, the initial segmentation data 402 may have some groups of outlier pixels 404 that do not connect to other groups of pixels that are predicted to represent haul roads. Because haul roads may be designed to be continuous such that machines 116 may travel to any point along the haul roads, it may be relatively likely that such disconnected groups of outlier pixels 404 do not actually represent haul roads. Accordingly, the post-processing component 134 may use noise correction techniques, binary closing techniques, and/or other image processing techniques to adjust the image mask indicated by the initial segmentation data 402 by removing the outlier pixels 404, in order to generate and/or output modified segmentation data 406 as shown in FIG. 4. The modified segmentation data 406 may be used as the final segmentation data 106 that is produced and/or output via the computing system 102.

In some examples, the post-processing component 134 may use other techniques to modify the initial segmentation data 402 into the modified segmentation data 406. As an example, the initial segmentation data 402 may include an image mask of haul roads that has continuous areas of pixels that are predicted to represent hauls roads, but that indicates that there is a gap between portions of a haul road. In this example, if the segmentation data 106 also includes an image mask of bodies of water or an image mask of machines 116, one those image masks indicate that the pixels associated with the gap in the haul road are likely to be associated with water or a machine 116 covering the haul road, the post-processing component 134 may add pixels to the image mask of the haul roads to remove the gap and indicate that the haul road extends continuously through the location where the gap had been.

In some examples, the post-processing component 134 may use telematics data 136 associated with movements and/or other operations of machines 116 to contextually determine whether or not to remove or add pixels associated with image masks associated with different types of elements 114. For example, if the initial segmentation data 402 is an image mask of pixels representing haul roads, and includes indicates a group of disconnected outlier pixels 404, and telematics data 136 indicates that no machines 116 have ever traveled along areas of the worksite 108 represented by the group of disconnected outlier pixels 404, the post-processing component 134 may determine that the group of disconnected outlier pixels 404 is unlikely to represent an actual haul road and may remove those outlier pixels 404 instead of connecting them to other pixels representing haul roads.

The post-processing component 134 may also use telematics data 136 to indicate other information in the modified segmentation data 406. For instance, based on telematics data 136, the post-processing component 134 may add tags, metadata, and/or other types of contextual data that may provide further information beyond the locations, boundaries, and/or locations of elements 114 at the worksite 108.

As an example, the initial segmentation data 402 generated the semantic segmentation model 104 may include an image mask of pixels representing stockpiles, for instance as shown in FIG. 3. However, although the initial segmentation data 402 may indicate pixels that are likely to represent stockpiles, the initial segmentation data 402 may not indicate which types of material are stored in each of the stockpiles. However, the post-processing component 134 may use telematics data 136 to determine which types of material machines 116 have removed from, or added to, the locations of the stockpiles identified by the initial segmentation data 402. The post-processing component 134 may add corresponding material classification tags or metadata to the image mask of the stockpiles, to indicate which types of material are likely to associated with individual stockpiles and/or individual pixels associated with corresponding stockpiles. Accordingly, the modified segmentation data 406 output by the post-processing component 134 may be modified to indicate material classifications and/or other types of contextual data, instead of or in addition to being modified to clean up noise or adjust for likely prediction errors.

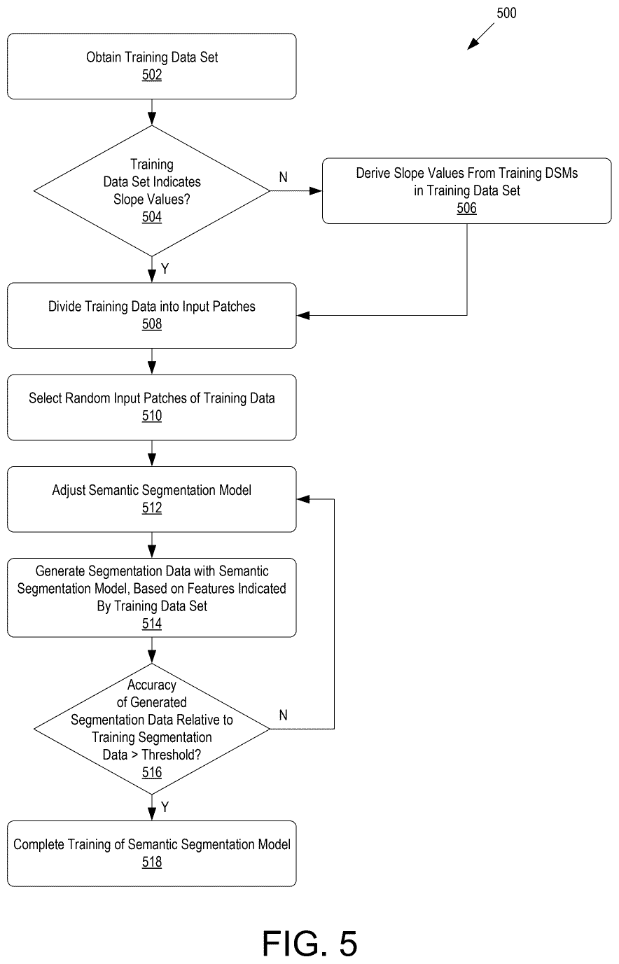

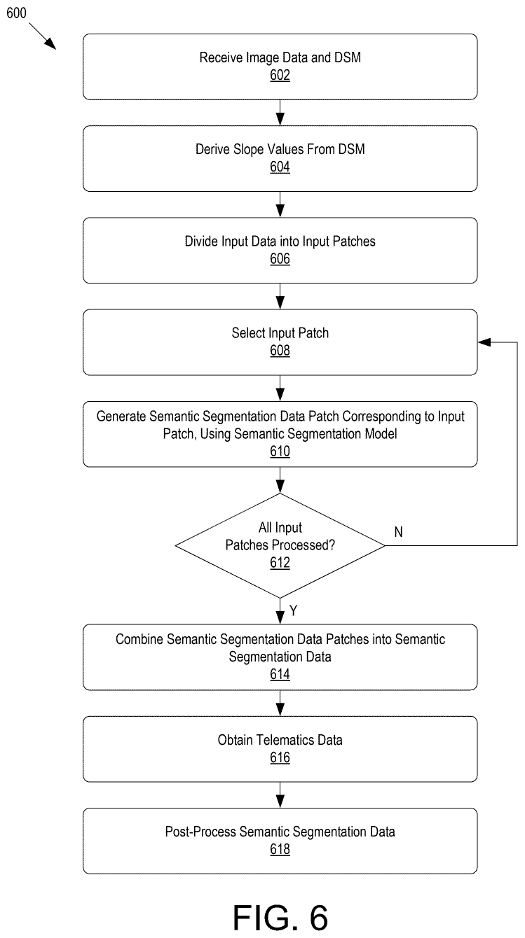

As shown in FIG. 3 and FIG. 4, the semantic segmentation model 104 may use input data, associated with image data 110 and/or a DSM 112, to generate corresponding segmentation data 106 indicating locations, boundaries, and/or types of elements 114 at the worksite 108. The post-processing component 134 may modify the segmentation data 106 generated by the semantic segmentation model 104. Training of the semantic segmentation model 104, and use of the trained semantic segmentation model 104, is discussed further below with respect to FIG. 5 and FIG. 6.

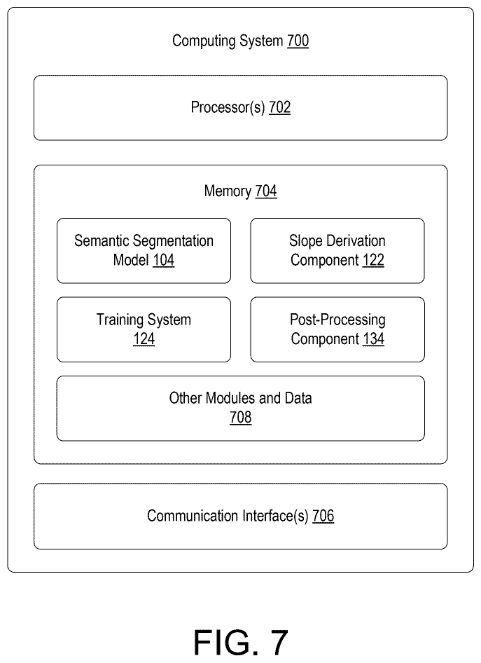

FIG. 5 is a flowchart 500 illustrating an exemplary process for training the semantic segmentation model 104. The operations shown in FIG. 5 may be performed by one or more computing systems, such as a computing system that executes the training system 124. FIG. 7, discussed further below, describes an example system architecture for such a computing system. In some examples, the computing system that executes the training system 124 and trains the semantic segmentation model 104 may be different, and/or remote from, the computing system 102 that executes a trained instance of the semantic segmentation model 104. However, in other examples, the same computing system may train the semantic segmentation model 104 and also execute a trained instance of the semantic segmentation model 104.

At block 502, the computing system may obtain the training data set 126. The training data set 126 may include training image data 128, such as orthophotographs and/or other images depicting one or more example worksites. The training data set 126 may also include training DSMs 130, such as DSMs that indicate elevation values associated with the one or more example worksites. The training data set 126 may also include training segmentation data 132 that indicates locations, boundaries, and/or types of elements 114 that were present at the one or more example worksites. The training segmentation data 132 may be generated by one or more human analysts, such as subject matter experts, and may accordingly be considered to be ground truth data of targets to be predicted during the training of the semantic segmentation model 104.

At block 504, the computing system may determine whether the training data set 126 indicates slope values. The training DSMs 130 may indicate elevation values, from which corresponding slope values may be derived. If slope values have not yet been derived from the elevation values indicated by the training DSMs 130 (Block 504—No), the computing system may derive such slope values from the elevation values indicated by the training DSMs 130 at block 506. For example, at block 506, the computing system may use an instance of the slope derivation component 122 to derive slope values from the training DSMs 130. The derived slope values may be added to the training data set 126. After deriving the slope values at block 506, or if the training data set 126 already indicated slope values (Block 504—Yes), the computing system may move to block 508.

At block 508, the computing system may divide the training data into input patches. For instance, the computing system may identify sets of training image data 128, training DSMs 130, slope values derived from training DSMs 130, and training segmentation data 132 that represent the states of the example worksites at substantially the same times, and may divide associated pixels and/or corresponding information into input patches that represent the same areas of the example worksites.

As an example, at block 508 the computing system may divide an orthophotograph of an example worksite into a set of rectangular patches. The computing system may pair the pixels of each rectangular patch of the orthophotograph with elevation values and slope values associated with the locations that are represented by each of the pixels in the rectangular patch. The computing system may also determine which type of element 114 the training segmentation data 132 indicates was present at the locations represented by the pixels of the rectangular patches. The computing system may store the input patches, for instance in local storage associated with the training system 124 and/or in remote storage that is accessible by the training system 124 via a network or other data connection.

At block 510, the computing system may select random input patches of training data, from among the patches divided at block 508. The computing system may access or retrieve the randomly-selected input patches, and may use the randomly-selected input patches to train the semantic segmentation model 104. In other examples, the computing system may skip block 510, and may instead train the semantic segmentation model 104 based on all of the input patches of the training data or on other groups of selected input patches.

At block 512, the computing system may adjust the semantic segmentation model 104. For instance, the computing system may select or types and/or numbers of predictive features to be evaluated and/or used to generate segmentation data 106, selecting or adjusting weights associated with the predictive features, and/or by selecting or adjusting other parameters associated with the semantic segmentation model 104.

During a first pass through block 512, the computing system may select initial parameters for the semantic segmentation model 104. For example, the computing system may be configured to initialize the semantic segmentation model 104 to evaluate an initial set of features associated with color channels of an orthophotograph 302, elevation data 304, and slope data 306 as discussed above with respect to FIG. 3. As described further below, during subsequent passes through block 512, the computing system may adjust the parameters of the semantic segmentation model 104, for instance to increase or decrease weights associated with one or more features, to change the types and/or numbers of features evaluated by the semantic segmentation model 104, and/or to otherwise change the parameters of the semantic segmentation model 104.

At block 514, the computing system may use the semantic segmentation model 104 to generate segmentation data 106 based on currently-set parameters of the semantic segmentation model 104 and/or features indicated by the training data set 126. For example, the computing system may execute the semantic segmentation model 104 based on the currently-set parameters to generate segmentation data 106, for instance based on information indicated by color channels of an orthophotograph 302, elevation data 304, and/or slope data 306. The computing system may execute the semantic segmentation model 104 at block 514 based on one or more input patches of training data, such as one or more input patches that were randomly selected at block 510.

At block 516, the computing system may determine whether an accuracy of the segmentation data 106 generated at block 514, relative to corresponding training segmentation data 132, exceeds a threshold. For example, the computing system may compare the segmentation data 106 generated at block 514 against corresponding training segmentation data 132, to determine how closely the locations, boundaries, and/or types of elements 114 indicated by the generated segmentation data 106 matches the locations, boundaries, and/or types of elements 114 indicated by the training segmentation data 132. In some examples, the computing system may compare image masks associated with one or more types of elements 114 indicated by the generated segmentation data 106 against corresponding image masks representing the same types of elements 114 indicated by the training segmentation data 132, to determine whether the image masks have at least a threshold amount or percentage of matching pixels.

If the accuracy of the generated segmentation data 106, relative to the training segmentation data 132, does not exceed an accuracy threshold (Block 516—No), the computing system may continue to train the semantic segmentation model 104 by returning to block 512 and adjusting the parameters of the semantic segmentation model 104. The computing system may generate new segmentation data 106 based on the training data and the adjusted parameters at block 514, and determine at whether the new segmentation data 106 has an accuracy, relative to the training segmentation data 132, that exceeds the accuracy threshold.

The computing system may continue training the semantic segmentation model 104 by repeating block 512, block 514, and block 516 until the accuracy of segmentation data 106 generated by the semantic segmentation model 104, relative to the training segmentation data 132, exceeds the accuracy threshold (Block 516—Yes). The computing system may accordingly complete the training of the semantic segmentation model 104 at block 518 when the semantic segmentation model 104 is able to generate segmentation data 106 that reproduces corresponding training segmentation data 132 to at least a threshold degree of accuracy.

When the computing system completes training and/or re-training of the semantic segmentation model 104, the computing system may store a trained version of the semantic segmentation model 104 in a location, such as server or other data storage location, that is accessible by the computing system 102 that executes the semantic segmentation model 104 to generate segmentation data 106 associated with the worksite 108, as discussed further below with respect to FIG. 6.

In some examples, the computing system may repeat one or more operations shown in FIG. 5 to re-train the semantic segmentation model 104 at one or more times. For example, new and/or updated training image data 128, training DSMs 130, and/or training segmentation data 132 may become available over time, such that the computing system may re-train the semantic segmentation model 104 based on a new or updated training data set 126.

As another example, over time the computing system may increase the accuracy threshold used at block 516, and may accordingly re-train the semantic segmentation model 104 to be more accurate relative to the training segmentation data 132. For example, the training system 124 may train a first version of the semantic segmentation model 104 until the semantic segmentation model 104 is able to reproduce training segmentation data 132 to at least a relatively low threshold degree of accuracy. Accordingly, the computing system 102 may begin using the first version of the semantic segmentation model 104 after the training system 124 has trained the first version of the semantic segmentation model 104. However, while the computing system 102 is using the first version of the semantic segmentation model 104, the training system 124 may increase the accuracy threshold and may train a second version of the semantic segmentation model 104 until the second version of the semantic segmentation model 104 is able to reproduce training segmentation data 132 to a higher threshold degree of accuracy. Accordingly, the computing system 102 may begin using the more accurate second version of the semantic segmentation model 104 after the training system 124 has trained the second version of the semantic segmentation model 104 based on a higher accuracy threshold.

FIG. 6 is a flowchart 600 illustrating an exemplary process for using the semantic segmentation model 104 to generate segmentation data 106 associated with the worksite 108. The operations shown in FIG. 6 may be performed by one or more computing systems, such as the computing system 102. FIG. 7, discussed further below, describes an example system architecture for such a computing system.

At block 602, the computing system may receive image data 110 and a DSM 112 from one or more data sources 120. For example, a drone or other data source 120 may use a camera to capture image data 110, such as an orthophotograph. A drone or other data source 120 may also use a LiDAR sensor, a camera, and/or other sensors 118 to measure elevation data indicated by the DSM 112. The one or more data sources 120 may provide captured data, such as the image data 110 and the DSM 112, or data from which the image data 110 and the DSM 112 may be derived, to the computing system at block 602 via a network or other data connection.

At block 604, the computing system may derive slope values from the DSM 112 received at block 602. For example, at block 604, the computing system may use the slope derivation component 122 to derive slope values associated with locations at the worksite 108 based on elevation values corresponding to those locations that are indicated by the DSM 112.

At block 606, the computing system may divide input data into input patches 206. The input data may include image data 110, elevation values indicated by the DSM 112, and slope values derived from the DSM 112. As an example, the computing system may divide pixels and/or corresponding information associated with an orthophotograph 302, elevation data 304, slope data 306 into various input patches that represent the same areas of the worksite 108. For instance, the computing system may divide the orthophotograph 302 into a set of rectangular patches, and pair the pixels of each rectangular patch with elevation values and slope values associated with the locations that are represented by each of the pixels in the rectangular patch.

At block 608, the computing system may select one of the input patches. At block 610, the computing system may use the semantic segmentation model 104 to generate a semantic segmentation data patch that corresponds to the selected input patch. As discussed above with respect to FIG. 5, the semantic segmentation model 104 may have been trained to determine which parameters and features in input data can be used to accurately predict corresponding semantic segmentation data 106. Accordingly, at block 608, the semantic segmentation model 104 may use those parameters and instances of features indicated by the selected input patch to generate a semantic segmentation data patch that corresponds to the selected input patch. For example, the semantic segmentation model 104 may be trained and/or configured to use features indicted by color channels of the input patch, features of elevation data 304 indicated by the input patch, and features of slope data 306 indicated by the input patch to generate the corresponding semantic segmentation data patch.

The semantic segmentation data patch generated at block 610 may indicate locations, boundaries, and/or types of the elements 114 present within an area of the worksite 108 represented by the selected input patch and the generated semantic segmentation data patch. In some examples, the generated semantic segmentation data patch may include image masks associated with different types of elements 114. Accordingly, an image mask of the semantic segmentation data patch that associated with a particular type of element 114 may identify pixels that represent locations at which that type of element 114 was present at the worksite 108.

At block 612, the computing system may determine if all of the input patches divided at block 606 have been processed via the semantic segmentation model 104 to generate corresponding semantic segmentation data patches. If any input patches have not yet been processed via the semantic segmentation model 104 (Block 612—No), the computing system may return to block 608 to select another input patch and then use the semantic segmentation model 104 at block 610 to generate a semantic segmentation data patch corresponding to that input patch.

After semantic segmentation data patches corresponding to all of the input patches have been generated by the semantic segmentation model 104 (Block 614—Yes), the computing system may combine the semantic segmentation data patches into full segmentation data 106 at block 614. For example, if the semantic segmentation data patches are rectangular images that each represent a relatively small area of the worksite 108, the computing system may stitch the semantic segmentation data patches together to generate a larger image that represents a larger area of the worksite 108. The segmentation data 106 assembled at block 614 may be associated with one or more image masks, such as image masks associated with different types of elements 114 that indicate pixels likely to represent locations at the worksite 108 where those different types of elements were present.

At block 616, the computing system may receive telematics data 136 associated with operations of machines 116 at the worksite 108. The telematics data 136 may indicate locations of the machines 116, routes traveled by the machines 116, speeds at which the machines 116 traveled, identifications of operations performed by the machines 116, information about payloads carried by the machines 116, such as weights, material types, and/or other payload information, and/or any other type of information. The computing system may receive such telematics data 136 from machines 116 directly, from a worksite management system, or from any other source.

At block 618, the computing system may post-process the segmentation data 106 generated at block 614, for instance to augment, enhance, or otherwise adjust the segmentation data 106. As an example, the computing system may adjust the segmentation data 106, using the post-processing component 134, to remove likely errors and/or to otherwise cause the segmentation data 106 to more accurately reflect actual locations, boundaries, and/or types of elements 114 at the worksite 108.

The post-processing component 134 may use noise correction techniques, binary closing techniques, and/or other image processing techniques to augment, enhance, or otherwise adjust the segmentation data 106. For example, the post- processing component 134 may evaluate image masks of generated segmentation data 106, and identify outlier pixels 404 that are disconnected from other pixels that represent a particular type of element 114. The post-processing component 134 may remove such outlier pixels 404 from the image mask based on a determination that the outlier pixels 404 are unlikely to actually represent locations associated with the particular type of element 114. Alternatively, if the post-processing component 134 determines that the outlier pixels 404 are likely to actually represent locations associated with the particular type of element 114, the post-processing component 134 may keep the outlier pixels 404 and/or may add other pixels to the image mask to connect the outlier pixels 404 to other pixels that represent locations associated with the particular type of element 114.

In some examples, the post-processing component 134 may use the telematics data 136 received at block 616 to augment, enhance, or otherwise adjust the segmentation data 106. As an example, if segmentation data 106 identifies locations of multiple individual stockpiles, and telematics data 136 indicates what types of material are present at those individual stockpiles, the post-processing component 134 may add tags, metadata, and/or other contextual data to the segmentation data 106 that identifies the types of material associated with the individual stockpiles.

The post-processing component 134 may also, or alternately, use the telematics data 136 to determine whether to delete or connect outlier pixels 404 in image masks associated with types of elements 114. For example, the segmentation data 106 may include an image mask associated with a particular type of element 114, and that image mask may include a set of disconnected outlier pixels 404. In this example, the post-processing component 134 may use the telematics data 136 to determine whether operations performed by machines 116 the worksite 108 at locations represented by the outlier pixels 404 indicate that the outlier pixels 404 likely do, or do not, actually represent the particular type of element 114. If the telematics data 136 indicates that operations associated with the particular type of element 114 have been performed at, or proximate to, the locations represented by the particular type of element 114, the post-processing component 134 may determine to keep and/or connect the outlier pixels 404. However, if the telematics data 136 indicates that operations associated with the particular type of element 114 have not been performed at, or proximate to, the locations represented by the particular type of element 114, the post-processing component 134 may instead determine to delete the outlier pixels 404.

The segmentation data 106 generated and post-processed via the operations shown in FIG. 6 may be displayed to users of the computing system 102 or other computing systems, may be provided to other systems, and/or may be used in other ways. For example, a worksite management system may use the locations, boundaries, and/or types of elements 114 indicated by the segmentation data 106 to assign machines 116 to perform operations at the worksite 108, and/or to track operations and/or productivity at the worksite 108.

FIG. 7 is a schematic illustration depicting an exemplary architecture of a computing system 700 that executes one or more elements described in the present disclosure. The computing system 700 may include one or more processors 702, memory 704, and communication interfaces 706. The computing system 700 may include one or more computers, servers, or other types of computing devices. Individual computing devices of the computing system 700 may have the system architecture shown in FIG. 7, or a similar system architecture.

The computing system 700 may execute one or more elements of the worksite segmentation system 100 described herein, such as the semantic segmentation model 104, the slope derivation component 122, the training system 124, the post-processing component 134, and/or other elements. The computing system 700 may also, or alternately, execute a worksite management system and/or other elements that receive and/or use segmentation data 106 generated by the semantic segmentation model 104.

In some examples, the computing system 700 may include one or more local servers and/or other local computing devices that are physically present at or near the worksite 108. In other examples, the computing system 700 may include one or more remote servers or other remote computing systems that are located at a remote location relative to the worksite 108. For instance, the computing system 700 may be executed via one or more remote servers, a cloud computing environment, or other computing systems or elements that are not present at the worksite 108.

In some examples, elements associated with the worksite segmentation system 100 may be distributed among, and/or be executed by, multiple computing systems or devices similar to the computing system 700 shown in FIG. 7. As an example, a trained version of the semantic segmentation model 104 may be executed by a different computing system than a computing system that trains the semantic segmentation model 104. As another example, the post-processing component 134 may be executed by a different computing system than a computing system that executes the semantic segmentation model 104. The computing system 700 may, in some examples, include or be part of a cloud computing environment or other distributed system that hosts and/or executes one or more elements associated with the worksite segmentation system 100.

The processor(s) 702 of the computing system 700 may operate to perform a variety of functions as set forth herein. The processor(s) 702 may include one or more chips, microprocessors, application specific integrated circuits (ASICs), field programmable gate arrays (FPGAs) and/or other programmable circuits, central processing units (CPUs), graphics processing units (GPUs), digital signal processors (DSPs), and/or other processing units or components known in the art. In some examples, the processor(s) 702 may have one or more arithmetic logic units (ALUs) that perform arithmetic and logical operations, and/or one or more control units (CUs) that extract instructions and stored content from processor cache memory, and executes such instructions by calling on the ALUs during program execution. The processor(s) 702 may also access content and computer-executable instructions stored in the memory 704, and execute such computer-executable instructions.

The memory 704 may be volatile and/or non-volatile computer-readable media including integrated or removable memory devices including random-access memory (RAM), read-only memory (ROM), flash memory, a hard drive or other disk drives, a memory card, optical storage, magnetic storage, and/or any other computer-readable media. The computer-readable media may be non-transitory computer-readable media. The computer-readable media may be configured to store computer-executable instructions that may be executed by the processor(s) 702 to perform the operations described herein.

For example, the memory 704 may include a drive unit and/or other elements that include machine-readable media. A machine-readable medium may store one or more sets of instructions, such as software or firmware, that embodies any one or more of the methodologies or functions described herein. The instructions may also reside, completely or at least partially, within the processor(s) 702 and/or communication interface(s) 706 during execution thereof by the computing system 700. For example, the processor(s) 702 may possess local memory, which also may store program modules, program data, and/or one or more operating systems.

The memory 704 may store data and/or computer-executable instructions associated with elements of the worksite segmentation system 100 described herein. For example, the memory 704 may store data and/or computer-executable instructions associated with the semantic segmentation model 104, the slope derivation component 122, the training system 124, the post-processing component 134, and/or other elements.

The memory 704 may also store other modules and data 708 that may be utilized by the computing system 700 to perform or enable performing any action taken by the computing system 700. For example, the other modules and data 708 may include a platform, operating system, and/or applications, as well as data utilized by the platform, operating system, and/or applications.

The communication interfaces 706 may include transceivers, modems, interfaces, antennas, and/or other components that may transmit and/or receive data over networks or other data connections. In some examples, the communication interfaces 706 may be wireless communication interfaces and/or wired communication interfaces that the computing system 700 may use to send and/or receive data. As an example, if the computing system 700 executes the semantic segmentation model 104, the slope derivation component 122, and/or the post-processing component 134, the computing system 700 may use the communication interfaces 706 to receive a trained instance of the semantic segmentation model 104 from the training system 124, to receive image data 110 and/or a DSM 112 from a drone or other data source 120, to receive telematics data 136 associated with one or more machines 116, and/or to send generated segmentation data 106 to one or more other elements.

### INDUSTRIAL APPLICABILITY

As described herein, the semantic segmentation model 104 may use image data 110 associated with a worksite 108, as well as elevation data and slope data indicated by and/or derived from a DSM 112 of the worksite 108, to generate segmentation data 106 that indicates locations, boundaries, and/or types of elements 114 at the worksite 108. One or more one or more data sources 120, such as an aerial drone, may capture the image data 110 and the DSM 112 that is used by the semantic segmentation model 104. Accordingly, when the one or more data sources 120 captures new image data 110 and a new DSM 112 representing a state of the worksite 108 at a particular time, the semantic segmentation model 104 may generate new segmentation data 106 that indicates locations, boundaries, and/or types of elements 114 present at the worksite 108 at that particular time.

Data sources 120 may also capture image data 110 and DSMs 112 associated with the worksite 108 at different times, such once per hour, once per day, or based on any other regular or irregular schedule. Accordingly, when new image data 110 and new DSMs 112 associated with the worksite 108 are captured at different times, the semantic segmentation model 104 may generate corresponding instances of the segmentation data 106 that indicate locations, boundaries, and/or types of elements 114 present at the worksite 108 at those different times. Differences between instances of the segmentation data 106 that are associated with different times may accordingly indicate changes over time to the locations, boundaries, and/or types of elements 114 present at the worksite 108.

Using the semantic segmentation model 104 to generate segmentation data 106 based on image data 110 and a DSM 112 may allow locations, boundaries, and/or types of elements 114 present at the worksite 108 to be determined automatically in a way that is quicker, cheaper, and/or more efficient than determining such information manually. For example, while human analysts may physically move around the worksite 108 to determine locations, boundaries, and/or types of elements 114 that are present at the worksite 108, it may take a human a relatively long period of time to survey the entire worksite 108 and to identify all of the elements 114 present at the worksite 108. Moreover, because the state of the worksite 108 may change relatively rapidly as operations are performed at the worksite 108, it may be difficult for a human to identify and keep up with dynamic changes to locations, boundaries, and/or types of elements 114 at the worksite 108 over a workday and/or other period of time. However, the semantic segmentation model 104 may automatically generate segmentation data 106 indicating such locations, boundaries, and/or types of elements 114, and/or changes relative to previous locations, boundaries, and/or types of elements 114 relatively quickly when new image data 110 and new DSMs 112 are captured by one or more drones or other data sources 120.

The segmentation data 106 generated automatically by the semantic segmentation model 104 may be used in various ways by one or more systems associated with the worksite 108. For example, a worksite management system executed via the computing system 102 or another computing system may use the segmentation data 106 to assign machines 116 to perform operations at the worksite 108, and/or to track operations and/or productivity at the worksite 108.

As an example, a worksite management system may assign machines 116 to travel along routes at the worksite 108 that extend along locations of haul roads that are identified by the segmentation data 106. The worksite management system may also assign machines 116 to travel to, or between, locations of stockpiles, loading areas, unloading areas, or other types of elements 114 that are identified by the segmentation data 106. The worksite management system may also assign machines 116 to load or unload one or more types of material at such locations based on information indicated by the segmentation data 106. For instance, if the post-processing component 134 used telematics data 136 to determine types of materials that are likely to be present at different stockpiles, and added corresponding tags or metadata to the segmentation data 106, the worksite management system may select particular stockpiles that machines 116 should visit based on the locations of those stockpiles indicated by the segmentation data 106 as well as the types of materials that the segmentation data 106 indicates are associated with those stockpiles.

As another example, the worksite management system may receive telematics data 136 indicating that a particular machine 116 transported a load of material from a first location to a second location at a particular time. In this example the telematics data 136 may have omitted information indicating what type of material was transported by the machine 116 during that particular time. However, the worksite management system may use the segmentation data 106 to determine that the first location was associated with a stockpile of a particular type of material, and thereby determine that the machine 116 transported that particular type of material at the particular time.

As yet another example, the worksite management system may use segmentation data 106 and/or differences between instances of segmentation data 106 to identify changes to the state of the worksite 108 over time, to track material movement at the worksite 108, to estimate amounts of material present at various locations at the worksite 108, and/or for other purposes. For instance, the segmentation data 106 may indicate a location and a boundary of a stockpile of material at a first period of time. The worksite management system may use the boundary of the stockpile indicated by the segmentation data 106 to determine a surface area covered by the stockpile, and may use elevation data and/or slope data indicated by the DSM 112 to determine a height of the stockpile, such that the worksite management system may use the area and the height of the stockpile to estimate a volume of material associated with the stockpile. If subsequent instances of the segmentation data 106 and/or the DSM 112 indicate changes to the area and/or height of the stockpile over a period of time, the worksite management system may use the subsequent instances of the segmentation data 106 and/or the DSM 112 to estimate changes to the volume of material associated with the stockpile and thereby determine how much material has been added to, or removed from, the stockpile.

The segmentation data 106 generated via the semantic segmentation model 104 described herein may also be more accurate than segmentation data that may be automatically generated by other semantic segmentation techniques. For instance, FIG. 8 is an exemplary diagrammatic illustration of an example comparison 800 of segmentation data generated via different techniques.

FIG. 8 shows a ground truth representation 802 of actual locations and boundaries of stockpiles at a worksite 108. FIG. 8 also shows an example of image-based segmentation data 804 that may be automatically generated by a U-Net model based only on an orthophotograph. The image-based segmentation data 804 may be generated by an instance of a U-Net model that has been trained and/or configured to use color data, such as data associated with a red channel, a green channel, and a blue channel, associated with an orthophotograph.

FIG. 8 also shows an instance of the segmentation data 106 that may be generated by the semantic segmentation model 104 described herein, based on image data 110 in combination with elevation values and slope values indicated by a DSM 112. Accordingly, although the semantic segmentation model 104 may be trained and/or configured to use color data, such as data associated with a red channel, a green channel, and a blue channel, associated with an orthophotograph or other image data 110, the semantic segmentation model 104 may be trained and/or configured to use elevation values indicated by a DSM 112 and slope values derived from the DSM 112 in addition to the color data indicated by the image data 110.

As shown in FIG. 8, the image-based segmentation data 804 that a U-Net model may generate from an orthophotograph alone may be noisy. The accuracy of the locations and boundaries of stockpiles indicated by the image-based segmentation data 804, generated from an orthophotograph alone, may also be low, relative to the actual locations and boundaries of the stockpiles indicated by the ground truth representation 802.

However, as shown in FIG. 8, the segmentation data 106 that the semantic segmentation model 104 generates based on image data 110 in combination with elevation values and slope values indicated by a DSM 112 may be relatively similar to the ground truth representation 802. Accordingly, the use of elevation values and slope values indicated by a DSM 112, in addition to image data 110, may allow the semantic segmentation model 104 to generate segmentation data 106 that is relatively similar to the ground truth representation 802, and that is thus more accurate at indicting the actual locations and boundaries of the stockpiles than the image-based segmentation data 804 generated from image data 110 alone.

While aspects of the present disclosure have been particularly shown and described with reference to the embodiments above, it will be understood by those skilled in the art that various additional embodiments may be contemplated by the modification of the disclosed machines, systems, and method without departing from the spirit and scope of what is disclosed. Such embodiments should be understood to fall within the scope of the present disclosure as determined based upon the claims and any equivalents thereof.

What is claimed is:

1. A computer-implemented method, comprising:
receiving, by a computing system comprising a processor, image data depicting a worksite;
receiving, by the computing system, a digital surface model (DSM) indicating elevation values corresponding to positions at the worksite;
deriving, by the computing system, slope values associated with the positions based on the elevation values indicated by the DSM; and
generating, by the computing system, and using a semantic segmentation model, semantic segmentation data that identifies:
one or more types of elements present at the worksite; and
locations of the one or more types of elements at the worksite,
wherein the semantic segmentation model is a machine learning model configured to generate the semantic segmentation data based on the image data, the elevation values, and the slope values.

2. The computer-implemented method of claim 1, wherein:
the semantic segmentation data comprises an image mask associated with a type of element of the one or more types of elements, and
pixels of the image mask correspond to particular locations of the type of element at the worksite.

3. The computer-implemented method of claim 2, further comprising post-processing the semantic segmentation data by:
identifying, by the computing system, outlier pixels that are disconnected, in the image mask, from other pixels that correspond to the type of element;
determining, by the computing system, and based on at least one of image processing techniques or telematics data indicative of operations performed at the worksite, that the outlier pixels are unlikely to represent the type of element associated with the image mask; and
deleting, by the computing system, the outlier pixels from the image mask.

4. The computer-implemented method of claim 2, further comprising post- processing the semantic segmentation data by:
identifying, by the computing system, outlier pixels that are disconnected, in the image mask, from other pixels that correspond to the type of element;
determining, by the computing system, and based on at least one of image processing techniques or telematics data indicative of operations performed at the worksite, that the outlier pixels are likely to represent the type of element associated with the image mask;
determining, by the computing system, and based on the at least one of the image processing techniques or the telematics data, that the image mask likely omits additional pixels corresponding to additional locations of the type of element at the worksite; and
adding, by the computing system, the additional pixels to connect the outlier pixels with the other pixels in the image mask.

5. The computer-implemented method of claim 1, further comprising post- processing the semantic segmentation data by:
receiving, by the computing system, telematics data indicative of operations performed at the worksite; and
adding, by the computing system, and based on the telematics data, contextual data to the semantic segmentation data in association with individual instances of the one or more types of elements,
wherein the contextual data indicates additional information associated with the individual instances based on the operations performed at the worksite.

6. The computer-implemented method of claim 1, further comprising:
providing, by the computing system, the semantic segmentation data to a worksite management system configured to at least one of:
assign machines to perform operations at the worksite based on the one or more types of elements, and the locations of the one or more types of elements, identified by the semantic segmentation data, or
track productivity at the worksite based on the one or more types of elements, and the locations of the one or more types of elements, identified by the semantic segmentation data.

7. The computer-implemented method of claim 1, wherein the semantic segmentation data is first semantic segmentation data representing a first state of the worksite at a first time, and the method further comprises:
receiving, by the computing system, second image data depicting the worksite at a second time;
receiving, by the computing system, a second DSM indicating second elevation values corresponding to the positions at the worksite;
deriving, by the computing system, second slope values associated with the positions based on the second elevation values indicated by the second DSM; and
generating, by the computing system, and using the semantic segmentation model, second semantic segmentation data that identifies:
the one or more types of elements present at the worksite at the second time; and
locations of the one or more types of elements at the worksite at the second time,
wherein differences between the first semantic segmentation data and the second semantic segmentation data are indicative of changes at the worksite between the first time and the second time.

8. The computer-implemented method of claim 1, wherein:
the image data is an orthophotograph, and
the semantic segmentation model is a U-Net image segmentation model configured to generate the semantic segmentation data based on features in:
a plurality of color channels associated with the orthophotograph;
an elevation channel corresponding to the elevation values indicated by the DSM; and
a slope channel corresponding to the slope values derived from the DSM.

9. The computer-implemented method of claim 1, wherein the image data and the DSM is received from an aerial drone that uses one or more sensors to capture the image data and the DSM while the aerial drone is flying over the worksite.

10. The computer-implemented method of claim 1, wherein:
the semantic segmentation model is trained based on a training data set comprising:
training image data depicting at least one example worksite;
training DSMs indicative of example elevation values and example slope values associated with the at least one example worksite; and
training segmentation data that identifies:
actual types of elements present at the at least one example worksite; and
actual locations of the actual types of elements at the at least one example worksite, and
the semantic segmentation model is trained to identify features, indicated by the training image data, the example elevation values, and the example slope values, that allows the semantic segmentation model to predict the actual types of elements and the actual locations of the actual types of elements indicated by the training segmentation data.

11. The computer-implemented method of claim 10, wherein the semantic segmentation model uses instances of the features, identified via training of the semantic segmentation model, and indicated by the image data, the elevation values, and the slope values associated with the worksite, to generate the semantic segmentation data associated with the worksite.

12. A computing system, comprising:
a processor; and
a memory having stored thereon computer-executable instructions that, when executed by the processor, cause the processor to:
receive, from at least one data source:
image data depicting a worksite; and
a digital surface model (DSM) indicating elevation values corresponding to positions at the worksite;
derive slope values associated with the positions, based on the elevation values indicated by the DSM; and
generate, using a semantic segmentation model, semantic segmentation data that identifies:
one or more types of elements present at the worksite; and
locations of the one or more types of elements at the worksite,
wherein the semantic segmentation model is a machine learning model configured to generate the semantic segmentation data based on the image data, the elevation values, and the slope values.

13. The computing system of claim 12, wherein:
the semantic segmentation data comprises an image mask associated with a type of element of the one or more types of elements,
pixels of the image mask correspond to particular locations of the type of element at the worksite, and
the computer-executable instructions cause the processor to modify the pixels of the image mask based on at least one of image processing techniques or telematics data indicative of operations performed at the worksite.

14. The computing system of claim 12, wherein:
the computer-executable instructions cause the processor to:
receive telematics data indicative of operations performed at the worksite; and
add, based on the telematics data, contextual data to the semantic segmentation data in association with individual instances of the one or more types of elements, and
the contextual data indicates additional information associated with the individual instances based on the operations performed at the worksite.

15. The computing system of claim 12, wherein the computer-executable instructions cause the processor to provide the semantic segmentation data to a worksite management system configured to at least one of:
assign machines to perform operations at the worksite based on the one or more types of elements, and the locations of the one or more types of elements, identified by the semantic segmentation data, or
track productivity at the worksite based on the one or more types of elements, and the locations of the one or more types of elements, identified by the semantic segmentation data.

16. The computing system of claim 12, wherein:
the semantic segmentation model is trained based on a training data set comprising:
training image data depicting at least one example worksite;
training DSMs indicative of example elevation values and example slope values associated with the at least one example worksite; and
training segmentation data that identifies:
actual types of elements present at the at least one example worksite; and
actual locations of the actual types of elements at the at least one example worksite, and
the semantic segmentation model is trained to identify features, indicated by the training image data, the example elevation values, and the example slope values, that allows the semantic segmentation model to predict the actual types of elements and the actual locations of the actual types of elements indicated by the training segmentation data.

17. One or more non-transitory computer-readable media having stored thereon computer-executable instructions that, when executed by a processor, cause the processor to:
receive, from at least one data source:
image data depicting a worksite; and
a digital surface model (DSM) indicating elevation values corresponding to positions at the worksite;
derive slope values associated with the positions, based on the elevation values indicated by the DSM; and
generate, using a semantic segmentation model, semantic segmentation data that identifies:
one or more types of elements present at the worksite; and
locations of the one or more types of elements at the worksite,
wherein the semantic segmentation model is a machine learning model configured to generate the semantic segmentation data based on the image data, the elevation values, and the slope values.

18. The one or more non-transitory computer-readable media of claim 17, wherein:
the semantic segmentation data comprises an image mask associated with a type of element of the one or more types of elements,
pixels of the image mask correspond to particular locations of the type of element at the worksite, and
the computer-executable instructions cause the processor to modify the pixels of the image mask based on at least one of image processing techniques or telematics data indicative of operations performed at the worksite.

19. The one or more non-transitory computer-readable media of claim 17, wherein:
the computer-executable instructions cause the processor to:
receive telematics data indicative of operations performed at the worksite; and
add, based on the telematics data, contextual data to the semantic segmentation data in association with individual instances of the one or more types of elements, and
the contextual data indicates additional information associated with the individual instances based on the operations performed at the worksite.

20. The one or more non-transitory computer-readable media of claim 17, wherein:
the semantic segmentation model is trained based on a training data set comprising:
training image data depicting at least one example worksite;
training DSMs indicative of example elevation values and example slope values associated with the at least one example worksite; and
training segmentation data that identifies:
actual types of elements present at the at least one example worksite; and
actual locations of the actual types of elements at the at least one example worksite, and
the semantic segmentation model is trained to identify features, indicated by the training image data, the example elevation values, and the example slope values, that allows the semantic segmentation model to predict the actual types of elements and the actual locations of the actual types of elements indicated by the training segmentation data.
